(19) United States
(12) Patent Application Publication
(10) Pub. No.: US 2022/0012030 A1
(43) Pub. Date: Jan. 13, 2022

(54) CONTAINER SYSTEM FOR AUTOMATING APPLICATION DEPLOYMENT IN A CLOUD INFRASTRUCTURE

(71) Applicant: HashiCorp, San Francisco, CA (US)

(72) Inventor: Rosemary Wang, Jersey City, NJ (US)

(21) Appl. No.: 16/925,150

(22) Filed: Jul. 9, 2020

(51) Int. Cl. G06F 8/60; H04L 12/24

(52) U.S. Cl. CPC G06F 8/60; H04L 41/5096; H04L 41/5045

(57) ABSTRACT

A system and method are described for creating application-related infrastructure resources from an application deployment platform (ADP), but which can have a single audit trail and common enforcement point of policies. A workspace custom resource definition (CRD) is generated to define a workspace schema for the workspace. The workspace schema represents a collection of configurations and variables for operating the infrastructure resources. An infrastructure controller (IC) operator is provided to the ADP to extend the API for communication with an infrastructure controller (IC), which has a set of IC definitions that define the infrastructure resources for the workspace. The workspace is built with the infrastructure resources defined by a workspace custom resource, and the CRD is deployed to the ADP via the IC operator to create the workspace custom resource based on the collection of configurations and the one or more variables.

### TECHNICAL FIELD

The subject matter described herein relates to cloud computing, and more particularly to a system and method for configuring and deploying cloud application-related infrastructure to a workspace via an application deployment platform.

### BACKGROUND

Cloud computing relates to running computing workspaces, including, but not limited to, application execution, secrets management, access control, and configuration management, in one or more cloud computing environments that abstract, pool and share scalable computing resources across one or more networks. Cloud computing also relates to workloads performed in the workspaces.

Computer hardware and software resources needed for cloud computing are known as cloud infrastructure, which include application-building tools, storage, networking infrastructure, and abstractions of these and other resources. Abstraction, or virtualization, of infrastructure resources allows for rapid configuration, allocation, deployment, and modification of applications and data in a cloud computing environment, without the need to change the underlying hardware and software resources that define a cloud infrastructure.

There are a number of cloud infrastructure provisioning applications and services, referred to herein as “Infrastructure Controller (IC)” such as Terraform® by HashiCorp, which is particularly configured for provisioning multi-cloud infrastructure, i.e., cloud infrastructure from multiple cloud service providers. Service providers may include Amazon Web Services, Google Cloud Platform, Microsoft Azure, and others. Terraform is an open-source, infrastructure-as-code (IaC) software tool that enables users to define and provision cloud infrastructure using a high-level configuration language known as Hashicorp Configuration Language (HCL), or optionally JavaScript Object Notation (JSON). ICs such as Terraform are used for building, changing, and versioning infrastructure safely and efficiently.

Cloud applications and services are deployed to cloud infrastructure and managed by an Application Deployment Platform (ADP) such as Kubernetes. Kubernetes is configured as a cluster to run application deployment workloads by configuring containers (which contains the compiled code of an application and any resources and services the application needs) for standardized and repeatable application deployment and execution. The configuration of each application and service is managed at the container level via a set of application programming interfaces (APIs).

An operator pattern extends the Kubernetes APIs to create and configure custom resources to capture and automate tasks of a human operator or application developer. A custom resource is an extension of the Kubernetes API that is not necessarily available in a default Kubernetes installation. The operator pattern leverages Kubernetes control loops to create, read, update, and destroy resources. The operator framework includes code to construct a controller for a custom resource, which includes a Custom Resource Definition (CRD) to define API objects.

Operators are software extensions to Kubernetes that make use of custom resources to manage applications and their components. Operators are clients of the Kubernetes API that act as controllers for a custom resource. Some projects attempt to leverage the Operator framework with a declarative approach, such as with Terraform. However, they either require Custom Resource Definitions (CRDs) for each provider or retrieve configuration from a module source to execute locally. Separately, some tools approach Custom Resource creation as management add-ons for a virtualization type.

Provisioning cloud computing workspaces—i.e. cloud infrastructure and the applications and services that run on the infrastructure—is conventionally performed by multiple, separate entities and with little to no integration. Accordingly, an IC that provisions infrastructure and an ADP that deploys applications to that infrastructure each maintains their own configuration management, audit trail, enforcement of policies, etc., and using different interfaces communication protocols.

### SUMMARY

This document describes a system and method for creating application-related infrastructure resources from application deployment platform, such as a Kubernetes cluster, but which can have a single audit trail and common enforcement point of policies, among other system integrations.

In some aspects, a workspace custom resource definition (CRD) is generated via an application deployment platform (ADP) to define a workspace schema for the workspace. The workspace schema represents one or more modules that model the workspace, each module being a collection of configurations to manage infrastructure resources of the workspace, and the collection of configurations including one or more variables for operating the infrastructure resources. The ADP is configured to containerize application-related resources for deployment to the workspace, the ADP having at least one application programming interface (API) via which the application-related resources are configured. An infrastructure controller (IC) operator is provided to the ADP to extend the API for communication with an infrastructure controller (IC), the IC having a set of IC definitions that define the infrastructure resources for the workspace, the IC operator being configured to reconcile the CRD with the set of IC definitions to provision the infrastructure resources for the ADP. The workspace is built with the infrastructure resources defined by a workspace custom resource, and the CRD is deployed to the ADP via the IC operator to create the workspace custom resource based on the collection of configurations and the one or more variables.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an [[INSERT BRIEF SUMMARY OF THE TECHNOLOGY YOU DON'T WANT TO BE LIMITED TO, IF APPLICABLE]], it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system showing features consistent with implementations of the current subject matter; and

FIG. 2 shows a process flow diagram illustrating aspects of a method having one or more features consistent with implementations of the current subject matter.

When practical, similar reference numbers denote similar structures, features, or elements.

### DETAILED DESCRIPTION

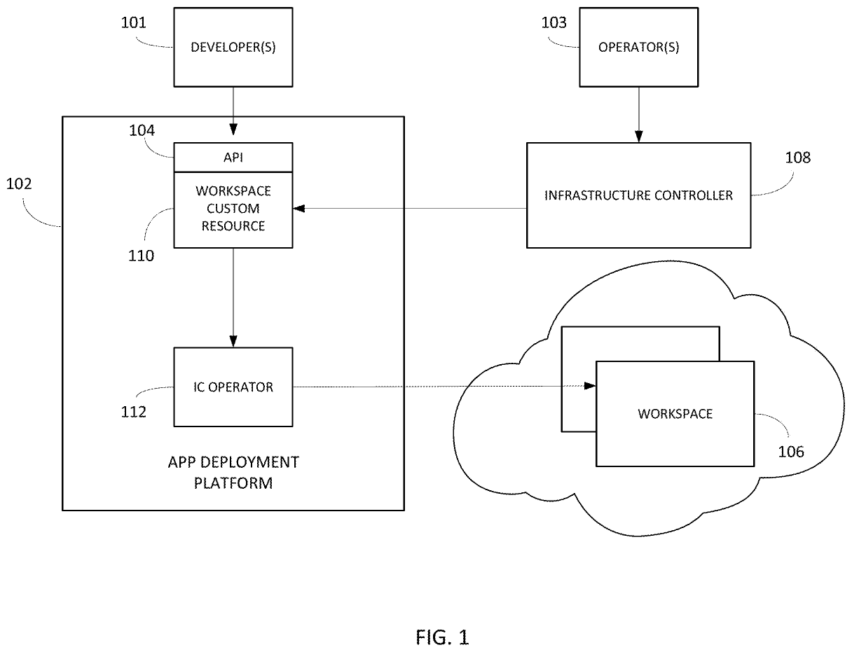

This document describes a system and method for configuring and deploying cloud application-related infrastructure to a cloud computing workspace via a cloud application deployment platform (ADP). An example of an ADP is a Kubernetes (K8s) platform. In preferred implementations, as illustrated in FIG. 1, a system 100 includes an ADP 102 that is configured to containerize, via an application programming interface (API) 104 or set of APIs, application-related resources for deployment to a workspace 106.

The system 100 includes an infrastructure controller (IC) 108 having a set of IC definitions that define infrastructure resources that are provisioned by the IC 108 for the workspace 106. An example of the IC 108 is a Terraform® Cloud by HashiCorp, Inc., an open-source infrastructure-as-code (IaC) software tool that automates provisioning, compliance and management of cloud infrastructure and infrastructure resources. The IC 108 also includes configuration management, auditing and tracking changes, policy enforcement, and secrets management. A secret is an object that contains a small amount of sensitive data such as a password, a token, or a key. Thus, the ADP 102 is configured for deployment of user applications, while the IC 108 manages the underlying infrastructure for the networks, storage, computing, databases, security, etc. that support the applications.

A workspace custom resource definition (CRD) 110 generated via the ADP 102 defines a workspace schema for the workspace, and represents one or more modules that model the workspace 106. Each module is a collection of configurations to manage the infrastructure resources of the workspace, where the collection of configurations include one or more variables for operating the infrastructure resources and are defined in the CRD 110.

The system further includes an IC operator 112 integrated with the ADP 102 to extend the API 104 for communication with the IC 108. The IC operator 112 includes a translation layer to enable calls from the ADP 102 to be made to the IC 108. The IC 108 contains the logic to handle infrastructure configuration and operations, while the IC operator 112 (extension) minimally communicates from the ADP 102 as to which logic for the IC 108 to execute. The IC operator 112 is configured to reconcile the CRD 110 with the set of IC definitions to provision the infrastructure resources for the ADP 102, and to deploy the CRD 110 to the ADP 102 via the IC operator 112 to create and build a workspace custom resource based on the collection of configurations and the one or more variables, enabling the ADP 102 to deploy the workspace with the infrastructure resources defined by the workspace custom resource.

The IC operator 112 encodes the information for the IC using the workspace custom resource defined by the workspace CRD 110. The infrastructure configuration is not directly encoded in the IC operator 112; instead it is pre-configured as an IC 108 module that is hosted within some public endpoint accessible to the IC 108. The IC operator 112 simply chooses that endpoint to retrieve the module containing the infrastructure configuration. There are specific parts of the infrastructure configuration that the operator specifies as “variables”, which do get passed to the IC module, but the high level configuration language is not directly defined by the IC operator and its interface. Accordingly, the IC operator 112 enables the IC 108 to leverage an existing control plane of the ADP 102 that ensures proper handling and locking of state, sequential execution of runs, and established patterns for injecting secrets and provisioning resources.

The system 100 allows for an end user to either interface with the IC 108 directly, or indirectly through the ADP 102. Further, the system 100 supports different user personas: human developers 101 use the ADP 102; human operators 103 use the IC 108. Beside supporting different personas, an organization can provide the IC operator 112 with the ADP 102 as an expression of the architecture of an application. In order to communicate and establish a shared understanding of infrastructure used to run the application, the organization can choose to use the provisioning manager to better articulate the shared architectural vision for the application ecosystem of infrastructure and application. Furthermore, the system 100 enables all changes to still go through IC 108, to provide a single audit trail and a common enforcement point of policies and other system integrations.

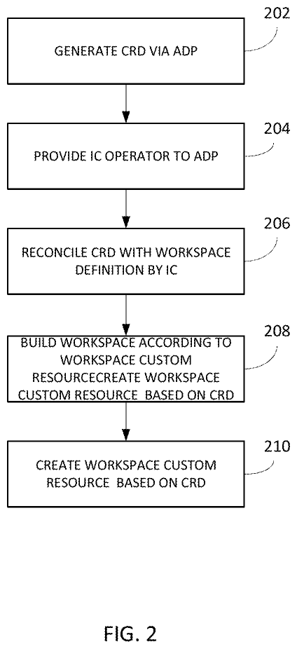

FIG. 2 is a flowchart of a method 200 of configuring and deploying cloud application-related infrastructure to a workspace via an application deployment platform (ADP). At 202, via the ADP, a workspace custom resource definition (CRD) is generated to define a workspace schema for the workspace. The workspace schema represents one or more modules that model the workspace, where each module is a collection of configurations to manage infrastructure resources provisioned for the workspace, and include one or more variables for operating the infrastructure resources. At 204, an IC operator is provided to the ADP to extend the ADP's API for communication with an infrastructure controller (IC), which has a set of IC definitions that define the infrastructure resources for the workspace. The IC operator is configured to retrieve values from the workspace definition, create or update a workspace, create or update variables in the workspace, and update a status or state of the workplace in the ADP.

The CRD defines variables and outputs to trigger a run in IC, and changing a variable will automatically re-execute a new run. At 206, the IC operator reconciles the CRD with the set of IC definitions to provision the infrastructure resources for the ADP. At 208, the workspace is then built with the infrastructure resources defined by the workspace custom resource. When a workspace is to be deleted, the IC operator will destroy the resources associated with the workspace. Then, at 210, the CRD is deployed to the ADP via the IC operator to create a workspace custom resource based on the collection of configurations and the one or more variables.

In some implementations, the IC operator is provided namespace-scoped to the ADP, to allow the IC operator to access an IC API token and workspace secrets within a specific namespace. By namespace-scoping the IC operator can isolate changes, scope secrets, and version CRDs.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for configuring and deploying cloud application-related infrastructure to a workspace via an application deployment platform (ADP), the ADP being configured to containerize application-related resources for deployment to the workspace, the ADP having at least one application programming interface (API) via which the application-related resources are configured, the method comprising:
generating, via the ADP, a workspace custom resource definition (CRD) to define a workspace schema for the workspace, the workspace schema representing one or more modules that model the workspace, each module being a collection of configurations to manage infrastructure resources of the workspace, the collection of configurations including one or more variables for operating the infrastructure resources;
providing an infrastructure controller (IC) operator to the ADP to extend the API for communication with an infrastructure controller (IC), the IC having a set of IC definitions that define the infrastructure resources for the workspace, the IC operator being configured to reconcile the CRD with the set of IC definitions to provision the infrastructure resources for the ADP;
building the workspace with the infrastructure resources defined by a workspace custom resource; and
deploying the CRD to the ADP via the IC operator to create the workspace custom resource based on the collection of configurations and the one or more variables.

2. The method in accordance with claim 1, wherein the IC includes a translation layer configured to enable calls from the ADP to be made to the IC.

3. The method in accordance with claim 1, wherein the IC operator is configured as a module of the IC that is hosted in a public endpoint accessible to the IC.

4. The method in accordance with claim 1, wherein the IC operator includes an interface between the IC and an existing control plane of the ADP for handling and locking of state, sequential execution of runs, and patterns for injecting secrets and provisioning resources of the workspace.

5. The method in accordance with claim 1, wherein the ADP is a Kubernetes-based platform.

6. The method in accordance with claim 5, wherein the Kubernetes-based platform is configured to containerize, via one or more of the APIs, application-related resources for deployment to the workspace.

7. The method in accordance with claim 1, wherein the IC is configured to receive changes to the workspace for a single audit trail.

8. A system for configuring and deploying cloud application-related infrastructure to a workspace via an application deployment platform (ADP), the ADP being configured to containerize application-related resources for deployment to the workspace, the ADP having at least one application programming interface (API) via which the application-related resources are configured, the system comprising:
a workspace custom resource definition (CRD) generated via the ADP that defines a workspace schema for the workspace, the workspace schema representing one or more modules that model the workspace, each module being a collection of configurations to manage infrastructure resources of the workspace, the collection of configurations including one or more variables for operating the infrastructure resources;
an infrastructure controller (IC) having a set of IC definitions that define the infrastructure resources for the workspace; and
an IC operator integrated with the ADP to extend the API for communication with the IC, the IC operator being configured to reconcile the CRD with the set of IC definitions to provision the infrastructure resources for the ADP, to deploy the CRD to the ADP via the IC operator to create a workspace custom resource based on the collection of configurations and the one or more variables, and to build the workspace with the infrastructure resources defined by the workspace custom resource.

9. The system in accordance with claim 8, wherein the IC includes a translation layer configured to enable calls from the ADP to be made to the IC.

10. The system in accordance with claim 8, wherein the IC operator is configured as a module of the IC that is hosted in a public endpoint accessible to the IC.

11. The system in accordance with claim 8, wherein the IC operator includes an interface between the IC and an existing control plane of the ADP for handling and locking of state, sequential execution of runs, and patterns for injecting secrets and provisioning resources of the workspace.

12. The system in accordance with claim 8, wherein the ADP is a Kubernetes-based platform.

13. The system in accordance with claim 12, wherein the Kubernetes-based platform is configured to containerize, via one or more of the APIs, application-related resources for deployment to the workspace.

14. The system in accordance with claim 8, wherein the IC is configured to receive changes to the workspace for a single audit trail.

15. A non-transitory computer readable storage medium including a set of instructions, wherein the instructions, when executed, cause a processor to:
generate, via an application deployment platform (ADP), a workspace custom resource definition (CRD) to define a workspace schema for the workspace, the workspace schema representing one or more modules that model the workspace, each module being a collection of configurations to manage infrastructure resources of the workspace, the collection of configurations including one or more variables for operating the infrastructure resources, the ADP being configured to containerize application-related resources for deployment to the workspace, the ADP having at least one application programming interface (API) via which the application-related resources are configured;
provide an infrastructure controller (IC) operator to the ADP to extend the API for communication with an infrastructure controller (IC), the IC having a set of IC definitions that define the infrastructure resources for the workspace, the IC operator being configured to reconcile the CRD with the set of IC definitions to provision the infrastructure resources for the ADP;
build the workspace with the infrastructure resources defined by a workspace custom resource; and
deploy the CRD to the ADP via the IC operator to create the workspace custom resource based on the collection of configurations and the one or more variables.

16. The non-transitory computer readable storage medium in accordance with claim 15, wherein the IC includes a translation layer configured to enable calls from the ADP to be made to the IC.

17. The non-transitory computer readable storage medium in accordance with claim 15, wherein the IC operator is configured as a module of the IC that is hosted in a public endpoint accessible to the IC.

18. The non-transitory computer readable storage medium in accordance with claim 15, wherein the IC operator includes an interface between the IC and an existing control plane of the ADP for handling and locking of state, sequential execution of runs, and patterns for injecting secrets and provisioning resources of the workspace.

19. The non-transitory computer readable storage medium in accordance with claim 15, wherein the ADP is a Kubernetes-based platform.

20. The non-transitory computer readable storage medium in accordance with claim 19, wherein the Kubernetes-based platform is configured to containerize, via one or more of the APIs, application-related resources for deployment to the workspace.
